(19) United States
(12) Patent Application Publication
(10) Pub. No.: US 2003/0153265 A1
(43) Pub. Date: Aug. 14, 2003

(54) Video and graphics distribution system for mobile users

(76) Inventor: Simon Hunt, Hampshire (GB)

Correspondence Address: Connolly Bove Lodge & Hutz, Suite 800, 1990 M Street N W, Washington, DC, 20036-3425, US

(21) Appl. No.: 10/240,942

(22) PCT Filed: Apr. 6, 2001
(86) PCT No.: PCT/GB01/01591

(30) Foreign Application Priority Data
Apr. 7, 2000 (GB) 0008501.9

(51) Int. Cl. H04H 7/00

(52) U.S. Cl. 455/3.06

(57) ABSTRACT

A distribution system that can push computer-generated information to a mobile/peripatetic device (6) interspersed with a stream of live video and audio communications. The system provides distribution means (4) for use with mobile telecommunications networks (5) wherein the user perceives the video streaming process to be in real time, and a mechanism switches the display to graphics/text when it is necessary to buffer the incoming video stream or when congestion or delays arise due to a network event. The system includes a plurality of transcoders (2) for the conversion of data/graphics from external information sources (17) into a display format suitable for display on a mobile receiving device and pushes the information from a central workstation to the mobile receiving device. The video and audio data are provided by a live video/audio stream source (3). The system includes a distribution switch (4) enabling control of the display on the mobile receiving device through a message protocol.

### FIELD OF THE INVENTION

This invention relates to a real time interactive system for peripatetic use in information provision and transactional purchasing for example.

### BACKGROUND OF THE INVENTION

Provision of the latest relevant information to an electronic display/storage device using wireless technology for peripatetic use is not a new concept. Likewise, the concept of live interaction via videophones is not new and considerable advances have been made in this field to develop mobile videophones. Yet both of these concepts are limited by the technology of the display device and the transmission protocols/medium to provide an effective mechanism for person to person interaction in a transactional exchange or in information provision.

For the past fifteen years, electronic handheld devices have been available in commercial form for the capture and transmission of data. Examples of their usage have been wide and varied from payment terminals for use by waiters in a restaurant to parcel tracking recorders for international couriers. Often these devices communicate to central computers via a batch style interface whereby data is stored in the handheld device and then transmitted at a convenient time. Advances in wireless radio technologies have enabled real time links, which in turn have encouraged applications that can take advantage of real time transmission of short data messages. Where the information that needs to be transmitted in real time is simple and short, these existing solutions are appropriate. Where information is complex requiring an involved dialogue, be it computer to computer or person to person, existing solutions are limited by the speed of the data transmission and size and resolution of the display device.

Handheld computers with display sizes matched to the physical size of the unit are in common use. These exist in the form of electronic organisers (diary, address book, notepad, etc), electronic games consoles, personal computers and more recently as mobile phones incorporating a range of personal and business application functionality. The latest generation may even access simple Internet sites via the use of transcoding gateways. Over the last decade the ability of these mobile devices to handle complex software applications has improved as advances have been made in microprocessor performance, miniaturisation of computer memory and dedicated low power chipsets to handle particular functions.

In particular, the electronics and software technology of the mobile telephone originally designed as a person to person audio communications device has advanced considerably. Subject to communications bandwidth availability, the personal videophone is close to becoming a commercial reality. Mobile telephones can also now incorporate computing functionality including online access to simple textual information services as well as camera and video compression technology to enable them to function as videophones or small screen television style video players.

Telephone functionality has also been combined with that of the PDA (Personal Data Assistant) computer to create a new generation of mobile computing/communications device. Whilst feature rich, these devices are limited in their functionality by microprocessor performance, computer memory and power consumption, i.e. the same problems faced by handheld computers. There is a perpetual trade off in this field whereby performance is never quite good enough to support the ideals of high quality, full motion video.

The limitations inherent in the electronic hardware hinder the application of these mobile or peripatetic devices to certain business applications. Typically these applications are ones that could benefit most from the real time interaction of person to person communications. In particular it may be appropriate to overcome the difficulties of conveying complex information on small display devices using the spoken word combined with facial expression than display long text descriptions. An example of this might be the fast face to face purchase between a customer and a travel agent for an airline ticket; as opposed to the customer browsing online menus with complex structures and long text descriptions to self select the item and complete the transaction details.

The most effective technology solution for mobile videophones is still open to debate. Many issues surround the choice of video compression algorithms to provide an effective smooth movement display. The current solutions are either based on wavelet algorithms or discrete cosine transform algorithms. Advances in both techniques have enabled video compression to be achieved that enables the use of low communications bandwidths (typically 128 kbps) or less. At these transmission speeds a compromise is made between picture size, picture quality and the latency of the encoding/decoding process to transform pictures into data streams and vice-versa.

Mobile videophone technology advancement is hindered by the need to keep the device small and consume low power (for long battery life) whilst carrying out intensive mathematical processing (to minimise communications bandwidth) in near real time (to minimise latency for picture transmission). In face to face communications, latency is important as a long delay inhibits the flow and synchronisation of person to person communications. Where the video picture uses pre-recorded material, for example a replay of a goal at a football match, latency is less of an issue, more important is the picture quality such that the fast movement of a small object e.g. the football, may be followed. Thus two different applications which might both be viewed on the same mobile display device have different priorities in the quality, size, latency trade off.

There is a need for a distribution system that may provide one way video communications from a central workstation to a mobile user whereby the live video display can be switched for simple textual/graphical information under the control of a fixed computer workstation or user. In this way the mobile/peripatetic device video decoder benefits from requiring reduced functionality (no encoding requirement) and can take advantage of non-contiguous bandwidth. The device may use a network that has a burst characteristic capable of transmitting large volumes of data for short periods, however unable to maintain this for long periods.

By pushing textual/graphical information to the mobile device this may be buffered and displayed whilst the video stream is effected by bandwidth congestion/delays. This makes for an efficient use of network capacity and is suited to a natural human communications process of “talk and show”.

The present invention accepts the limitations of video compression technology, small data displays and of the types of electronic hardware used in mobile phones/computers and aims to overcome them or substantially reduce their effects in the application of the devices for information provision and transactional services.

### OBJECT AND SUMMARY OF THE INVENTION

It is the principal objective of the present invention to provide a distribution system that can push computer-generated information to a mobile/peripatetic device interspersed with a stream of live video and audio communications.

The present invention uses centralised computer workstations and/or operators to push relevant information via a data transcoder (a process by which data formatting attributes are modified to enable display on a different device to that originally intended). The present invention is able to display this information to the user interspersed with live video of the operator whilst maintaining an audio conversation using the same transmission path. This process may take place without user intervention on the part of the mobile user, beyond initiating the call to the central station.

In accordance with an exemplary embodiment of the invention, comprising a video source/encoder, graphics/text transcoder and distribution system capable of managing a plurality of sources; the distribution switch and transcoder may be software adapted to operate on standard computer hardware.

In the exemplary embodiment, an interface is provided to a mobile telephony network to provide an interleaved stream of video, audio and data signals to a mobile device. In the mobile device a decoder displays the incoming stream such that the user perceives the process to be in real time (typically where the total delay is less than 500 milliseconds). A mechanism is provided to switch the display to graphics/text when it is necessary to buffer the incoming video stream. Advantageously, this event is reported to the central workstation to enable a human operator to maintain the flow of communication and information provision whilst live video is not visible on the recipients display screen.

Advantageously facilitating only a one way process enables transmission latency to be minimised by reduced the processing requirement of the mobile device.

Advantageously, switching the live video to a graphics display enables the use of a network transmission path without consistent bandwidth characteristics.

Advantageously, it is not mandatory that the mobile users have to select options with a keyboard or a pointing device. This enables the mobile device to be used for complex transactions and information provision where control of a small keyboard would be awkward e.g. whilst travelling in a moving vehicle or whilst in a cold environment wearing gloves.

The above and further features of the invention are described hereinafter with reference to the accompanying drawings.

### BRIEF DESCRIPTION OF THE DRAWINGS

FIG. 1 is a block diagram illustrating the system embodying the present invention.

FIG. 2 is a schematic diagram of the subsystem components showing the embodiment of the invention in greater detail;

FIG. 3 illustrates a typical sequence of views that may be experienced by the mobile user,

FIGS. 4 and 5 are example process diagrams representative of functions of the system of the invention in use.

### DETAILED DESCRIPTION OF AN EMBODIMENT OF THE INVENTION

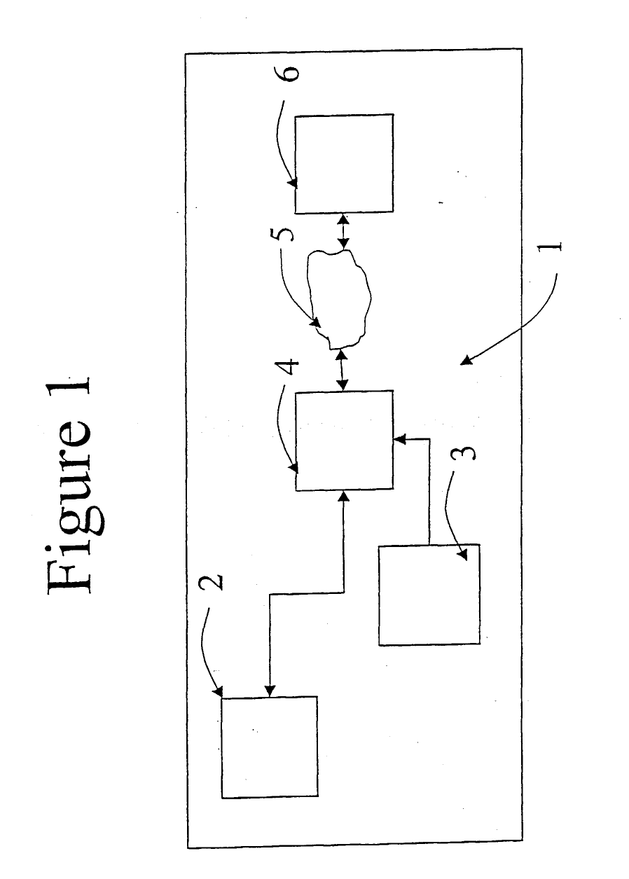

FIG. 1 is a schematic diagram of the information system 1 embodying the present invention. The system generally indicated at 1 comprises a text/graphical information transcoder 2 and a live video/audio stream source 3, connected to a distribution subsystem 4 for transmission across a wireless network 5 to a remote mobile receiving device 6.

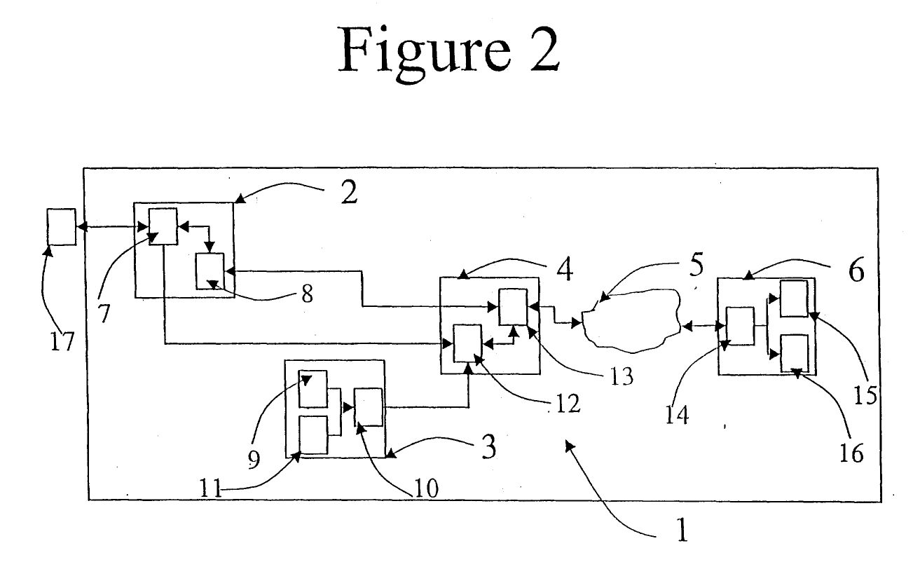

FIG. 2 of the drawings shows the subsystem components in greater detail. In this figure, the transcoder 2 comprises a computer hardware/software system capable of translating data from external workstations/information sources 17 into a format suitable for display on the mobile users receiving device 6. The transcoder comprises a transcoding object 7 and a presentation manager 8. There may be a plurality of transcoders. Advantageously the type of mobile receiving device is indicated automatically through the distribution subsystem 4 to the presentation manager 8. Where the destination device is unknown, for example where a new receiving device becomes available, a minimum display characteristic enables the device to be supported. Advantageously, where this occurs, the use of human voice communications as the control path from the receiving device 6 to the distribution subsystem 4 and presentation manager 8 eliminates the problems of potentially missing control functionality on the receiving device 6.

The transcoding module 7 is capable of pushing data from the external workstations/information sources 17 without the human user of the receiving device 6 having to enter keyboard or pointing device generated system commands to request the receipt of said information.

The live video stream source 3 may typically include a camera 9 from which the signals are digitally encoded with a digital codec 10 together with an accompanied audio stream from an audio source 11. The digital codec 10 might use, however is not limited to, compression techniques as described in standards by the Motion Picture Experts Group (MPEG) or wavelet techniques. Advantageously, the distribution subsystem 4 of the present invention is not limited by the particular implementation of video streaming.

The distribution switch subsystem 4 comprises a video/data interleave controller 12 and a transmission session manager 13. It performs the following important functions in the system of the invention:

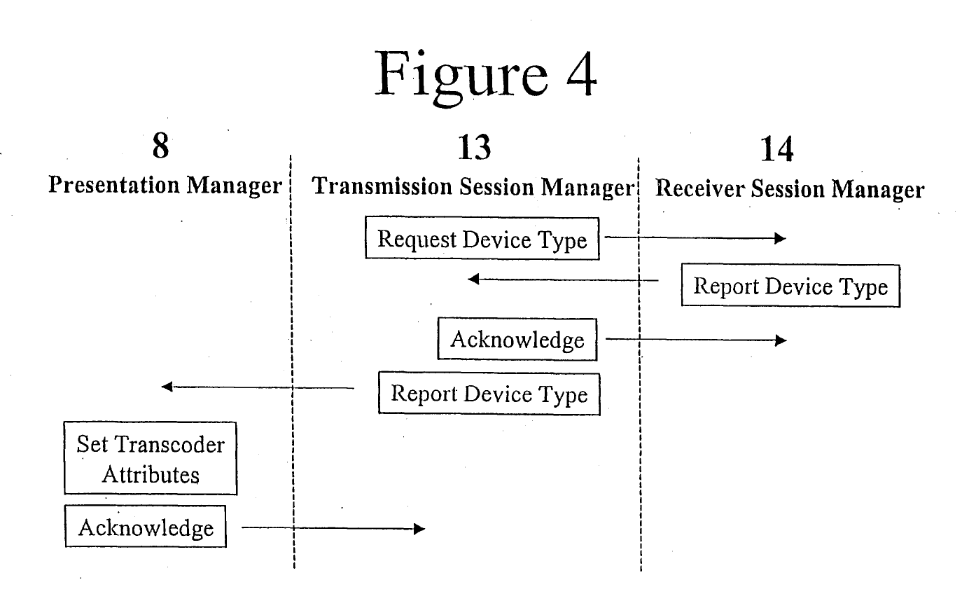

(1) The distribution subsystem 4 identifies the attributes of the mobile receiving device to enable the transcoding object 7 to present graphical and textual data in an appropriate viewable format. This is illustrated in FIG. 4.

(2) The distribution switch subsystem 4 controls the transmission of text/graphical data derived from the transcoder 2 using the video/data interleave controller 12 which operates under the control of the transmission session manager 13. The text/graphical data is interleaved with signals from the video/audio digital codec 10.

(3) The transmission session manager 13 may receive external requests using a message protocol from the presentation manager 8 to switch between live video and text/graphical display.

(4) The transmission session manager 13 indicates using a message protocol to the receiving device 6 whether a text/graphical display should be shown or the live video stream. The message protocol handler is resident with the receiver session manager 14.

(5) The transmission session manager 13 is notified using a message protocol by the receiving session manager 14 that network congestion/delay or another condition is resulting in interruption of the contiguous display of live video with acceptable latency.

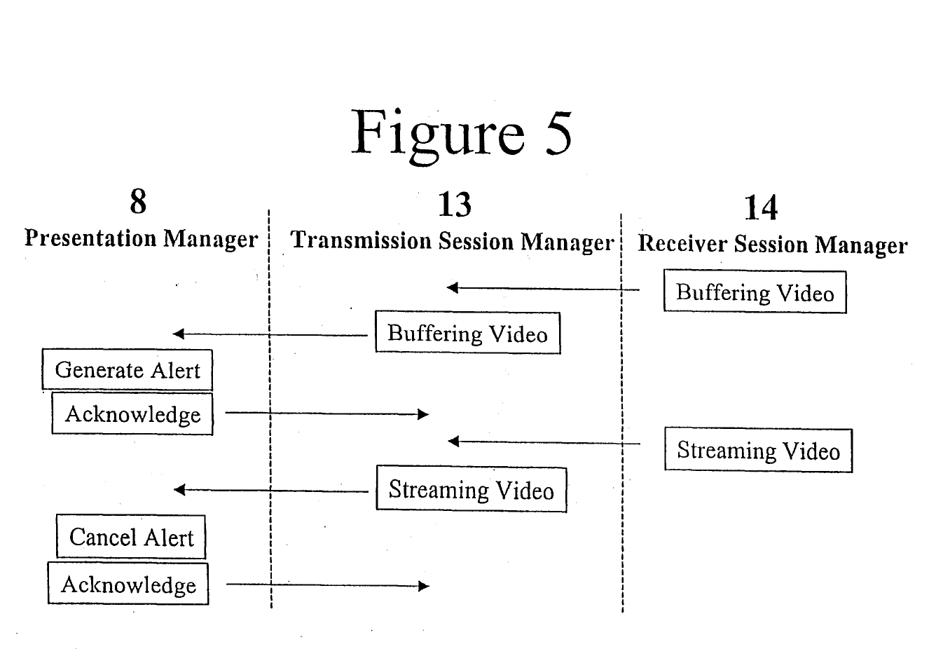

(6) The transmission session manager 13 reports the network congestion/delay to the presentation manager 8 to alert a human operator selecting information within the external information sources 17. This is illustrated in FIG. 5.

(7) The transmission session manager 13 reports and acts upon error conditions relating to the continuous display of live video or transition to graphics/text display on the receiving device 6.

(8) The distribution switch subsystem 4 contains facilities for configuration, operation and maintenance of the information system 1.

The receiving device 6 contains software (the receiving session manager 14) capable of responding to events from the transmission session manager 13 and capable of generating messages and alerts to the transmission session manager 13. The receiving device 6 also contains hardware or software (digital audio/video decoder 15) capable of decoding video streams (with a low latency performance based on the available digital coding techniques. Advantageously, the event handling software (receiver session manager 14), where required may include the decoding algorithms necessary for the interpretation and display of the streamed video, audio and data signals. The graphics/text are handled in the receiving device 6 by the presentation object 16.

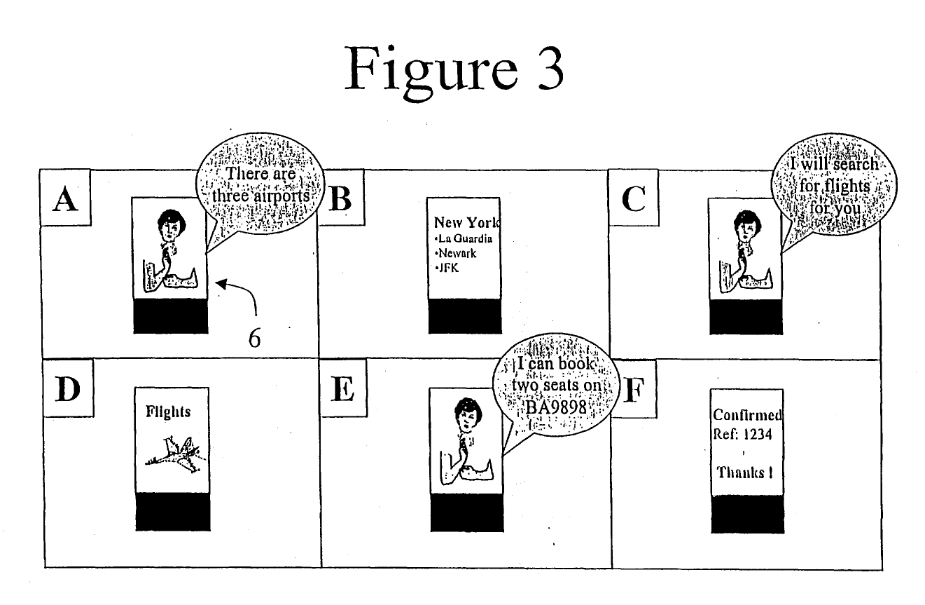

A static representation of a typical sequence of screens that a user with an appropriate receiving device 6 might experience is illustrated in FIG. 3. In the first transition (A-B) from video stream to graphics/text display it is an automated response generated by an event received via the transcoder. For example an operator using a workstation 17 attached to the transcoder might wish to show the mobile user with the receiving device 6 some simple text choices. In the second transition (C-D) from video stream to graphics/text display it is an automated response generated as a response to network congestion/delays reported by the receiving device 6. Networks typically have to manage contention between users by managing bandwidth. The communications protocols used are designed to handle this scenario. However, real time video streaming requires a transmission capacity that exceeds the selected streaming rate. To be sure of maintaining continuous streaming the quality of picture or latency of transmission needs to be degraded. By switching the receiving device 6 between graphics display and streaming under the control of the distribution switching subsystem 4, a better quality picture with lower latency may be provided.

Having thus described the invention by reference to an exemplary embodiment, it will be apparent to those with appropriate knowledge and skills that modifications and variations are possible without departing from the scope of the invention defined in the appending claims. For example, the system of the invention may be applied to other telecommunications network types. Therefore the spirit and scope of the appended claims should not be limited to the description of the preferred version contained herein.

1. A distribution system adapted and arranged to enable the provision of computer generated information interspersed with video and audio communications to a mobile/peripatetic device capable of reproducing the same to a user.

2. A distribution system adapted and arranged to enable the provision of computer generated information interspersed with video and audio communications from a central control station to a mobile receiver device capable of reproducing the same to a user, and wherein means are provided at the central control station to enable switching between video and graphics/text displays.

3. A distribution system as claimed in claim 2 wherein switching between video and graphics/text displays is arranged to be effected whilst maintaining said audio communication.

4. A distribution system as claimed in claim 2 or 3 wherein the arrangement is such that said information may be sent to the receiver device under centralized control without instructions being received from the receiver device to request the information.

5. A distribution system as claimed in claim 2 or 3 wherein said means to enable switching is arranged to be responsive to an event affecting the display of video.

6. A distribution system as claimed in claim 5 wherein said event comprises a perceived need to buffer an incoming video stream.

7. A distribution system as claimed in claim 5 wherein said event comprises bandwidth congestion/delays affecting an incoming video stream.

8. A distribution system as claimed in claim 6 or 7 wherein said means at the central control station is arranged to be responsive to a request from a mobile receiver device, the mobile receiver devices having the facility to make such requests.

9. A distribution system as claimed in any of claims 2 to 8 wherein said system is wireless based for communication between fixed and mobile stations.

10. A distribution system as claimed in any of claims 2 to 9 which is adapted and arranged to enable the display of computer generated information provided from an operator to an end user interspersed with live video of the operator whilst maintaining an audio communication facility with the operator over the same communications path.

11. A wireless based distribution system enabling the provision of graphics/text information interspersed with live video, together with continuous audio communication, from a central station to a plurality of mobile receiver devices capable of reproducing the same to a user, the system comprising:
a graphics/text information transcoder for interpreting for the receiver devices graphics/text information generated externally of the system;
a live video and audio stream source including encoding means; and
a distribution sub-system comprising an interleave controller coupled to said encoder and to said transcoder, and control means coupled to said interleave controller and to said transcoder for outputting to a wireless network signals representative of the required graphics/text, live video and audio content;
and each said mobile receiver device comprising:
control means receiving signals from said wireless network and communicating via said wireless network with said distribution system;
audio and video decoder means; and
graphics/text display handling means;
said control means of the receiver device co-operating via said wireless network with said control means of the distribution system to select for display either the live video or the graphics/text information.

12. A distribution system as claimed in claim 11 further comprising supervising means for providing a facility for overseeing the configuration and operation of the system in use.
